(19) United States
(12) Patent Application Publication
(10) Pub. No.: US 2008/0094971 A1
(43) Pub. Date: Apr. 24, 2008

(54) Device and Method for Providing Media-Related Parameters on a Medium and for Retrieving Such Parameters

(75) Inventor: Tony Petrus Van Endert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,029

(22) PCT Filed: Oct. 11, 2005
(86) PCT No.: PCT/IB05/53334

§ 371 Date: Apr. 11, 2007

(30) Foreign Application Priority Data
Oct. 18, 2004 (EP) 04105120.2

(51) Int. Cl. G11B 19/12; G11B 7/26; G11B 7/125

(52) U.S. Cl. 369/47.53

(57) ABSTRACT

The present invention relates to a record carrier, to a drive device for the record carrier, and to a method of providing at least one parameter that defines at least one characteristic of the record carrier on said record carrier. The at least one parameter is determined during a first access operation to the record carrier and is then written to a predetermined area of the record carrier by using a predetermined pattern of at least two different power levels. During a subsequent second access operation the at least one parameter is retrieved from the record carrier by detecting jitter values in the read-out signal. Thereby, a simple and reliable measure for storing and retrieving these parameters on the record carrier is provided.

The present invention relates to a device, especially to an optical disc drive, and to a method of providing at least one parameter that defines at least one characteristic of a record carrier, such as a rewritable optical disc. In particular, the present invention relates to providing such parameters of rewritable discs that will be loaded into the same drive device several times.

Record carriers, such as optical discs and other optical media, store data in a digital form. Optical disc type record carriers include various CD (Compact Disc) and DVD (Digital Versatile Disc) optical disc technologies. The stored data may consist of video, text, audio, computer data, or any other form of digital information. In the case of optical discs, this data is written to and read from such a disc by means of a radiation beam such as, for example, a laser light beam.

Many different formats and disc types are commercially available. Even within a standardized disc format, for example CD-R, CD-R/W, DVD-R and DVD-R/W, each type of optical disc may possess different material and/or disc properties. These properties can be quantified by one or more parameters. These different material and/or disc properties may cause different types of record carriers to behave differently when exposed to a radiation beam. In the absence of some kind of compensation, such differences in behavior may result in variations in the write performance, for example expressed by the jitter (i.e., the phase variation due to displacements of the written marks) and the asymmetry of the written marks. In order to compensate for material parameters and other disc-specific characteristics, and thereby to obtain an optimum write performance, it may thus be required to select different write strategies in dependence on the type of optical disc.

The term “mark” is to be understood to denote any type of detectable area on a record carrier. A “mark” may consist, for example, of a pit formed by local heating of an area on the record carrier or of an amorphous area in a crystalline layer in the record carrier. Alternatively, the term “mark” may designate a magnetic or electric domain in record carriers using other storage technologies. A write strategy is understood to be any sequence of writing signals and/or of taking measures that cause a mark to be formed on a record carrier.

When in recording apparatuses such as drive devices data is recorded by rotating the record carrier, for example an optical disc, with a Constant Angular Velocity (i.e., a CAV-system), the linear velocity increases linearly towards the outer periphery of the disc while the angular velocity remains constant. If a radiation source emits a radiation beam at a constant power, the quantity of heat radiated onto the recording surface of the record carrier gradually decreases as the linear velocity increases. For this reason it is necessary to increase the emitted power of the radiation source, for example a laser, in response to the increase in velocity in order to preserve the recording quality. Furthermore, an OPC (Optimum Power Calibration) procedure may be performed at various linear velocities, and the recording quality may be evaluated to obtain the optimum power of the radiation beam corresponding to each of the velocities.

Rewritable record carriers, such as multi-session dye media and phase change media, may be loaded several times into the same or into other drive devices. In general, the drive device will recognize the record carrier when the latter is loaded into the drive device, and subsequently will calibrate tilt, try to find the optimum write power (for example based on the above OPC procedure), and the like. This will be repeated each time after ejecting and re-loading of the record carrier into the drive device. As a consequence, the start-up time of the record carrier will stay high, even when the settings of the drive device have already been adapted to the record carrier before. The same applies to the time required for preparing a recording, so that the throughput time will be unnecessarily high.

Document US 2003/0058765 A1 discloses a method and a recording device for selecting an optimized write strategy, wherein information regarding the best write strategy for use with a specific disc is written onto the disc itself. When the disc is subsequently encountered by the recording device, this information is read from the disc and used by the recording device for selecting the best write strategy. In particular, the OPC area of a disc of a previously unregistered disc type is utilized to test various write strategies and settings, and, depending on the test results, the best possible write strategy is selected. The information identifying the selected best possible write strategy is written to an area on the disc comprising information regarding disc parameters such as, for example, the lead-in area of the disc. However, the above document does not provide any particulars on how information specifying the disc characteristics can be written to and read from an optical disc.

It is therefore an object of the present invention to provide a device, especially an optical disc drive device, a method, and a record carrier, designed such that information regarding specific characteristics of the record carrier can be provided on the record carrier.

This object is achieved by providing a device as claimed in claim 1, comprising determination means for determining at least one parameter which defines at least one characteristic of said record carrier, writing means for writing said determined at least one parameter to a predetermined area of said record carrier by using a predetermined pattern of at least two different power levels, and reading means for reading said at least one parameter from said predetermined area by detecting jitter values in a read-out signal. This object is further achieved by providing corresponding methods as claimed in claims 11 and 12, and by a record carrier as claimed in claim 13.

Accordingly, specific measures for providing carrier-specific information on the record carrier are defined, by means of which a simple and reliable provision of this carrier-specific information can be ensured. The use of a pattern of different power levels which can be retrieved from the record carrier based on jitter variations provides the advantage that no additional recording area has to be provided for storing the patterns. They may be recorded in an existing location, so that no change of the record carrier structure is required. Moreover, the start-up time and the delay between subsequent stop and write situations can be reduced, as no calibrations are required anymore during reading/writing from/on a “known” record carrier. The throughput rate is increased in this manner.

Conversion means for converting the predetermined pattern derived from the detected jitter values into the at least one parameter may be provided in the device. By using these conversion means the drive device can convert the patterns into the required disc parameters, and the start-up time for accessing the record carrier can be significantly reduced. In particular, the conversion means may comprise a programmable conversion table. This provides a flexible and adaptive use of the conversion means.

Furthermore, calibration means may be provided for calibrating the at least two different power levels, based on a jitter-related power control function used for setting an optimum power, when accessing the record carrier. This measure provides the advantage that the power values of the patterns are individually adapted to the record carrier so as to ensure an optimum reliability of the pattern-recording process. The calibration means may be arranged to select the at least two different power levels using a power-dependent jitter characteristic determined by a power control function. It can be ensured thereby that power levels are selected which can be well distinguished on the basis of jitter variations in the read-out signal.

The writing means may be arranged to write the predetermined pattern such that the duration of one power level corresponding to one logical value has a duration of at least one address frame of a pre-groove recording scheme, e.g. one ADIP (ADdress In Pre-groove) or ATIP (Absolute Time In Pre-groove frame). The jitter can then be read several times and the obtained values can be averaged to increase the reliability.

The predetermined pattern may be arranged as a pattern block comprising a first pattern for recognition, a second pattern for defining a type of the record carrier, a third pattern for defining the at least one parameter, and a fourth pattern for defining the end of the pattern block. The writing means may be arranged to repeat the pattern block at least once. The at least one pattern may define values of, for example, at least one of a tilt, a write power, a beta target, an RE (Radial Error) amplitude, and a fiddle factor. The beta value is generally defined as:

$$β = \frac{A 1 - \vert A 2 \vert}{A 1 + \vert A 2 \vert}$$

where A1 designates the amplitude of the read back RF signal in one direction and A2 designates the amplitude of the RF signal in the other direction. Hence, the beta value indicates the symmetry of the read RF signal. If there is a certain asymmetry in the RF signal, the write power has to be increased or decreased accordingly. The beta target or beta value is a parameter used in determining the optimal write power. It is indicated in the disc info stored in the ATIP/ADIP, but may not always be correct. Therefore, a new beta target can be determined from the optimal power obtained with a jitter-based OPC procedure. The beta target can then be determined, for example from a beta versus power curve or characteristic. The RE amplitude indicates the amplitude of the error signal (servo signal) in the radial direction of the disc, and the fiddle factors are fine-tuning factors of the write strategy which may be determined by experimental measurements.

If the record carrier is an optical disc, the predetermined area may comprise at least one of a recorded area indicator zone, an inner test zone, an outer test zone, an inner disc count zone, and an outer disc count zone. Predefined zones on the optical disc are thus used for writing the pattern of the at least one disc parameter.

Preferred embodiments of the present invention will now be described with reference to the accompanying drawings, in which:

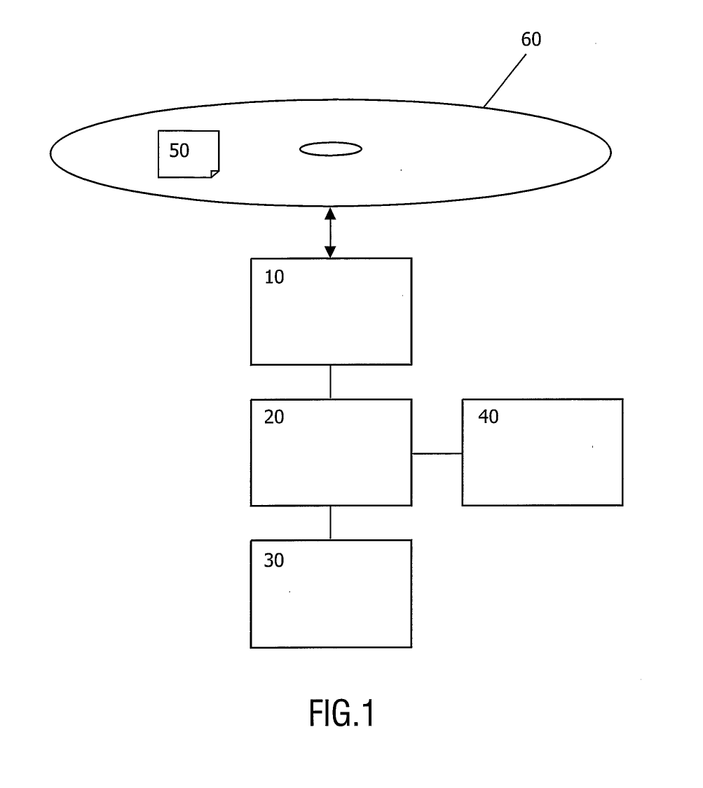

FIG. 1 is a schematic block diagram of a drive device according to a preferred embodiment,

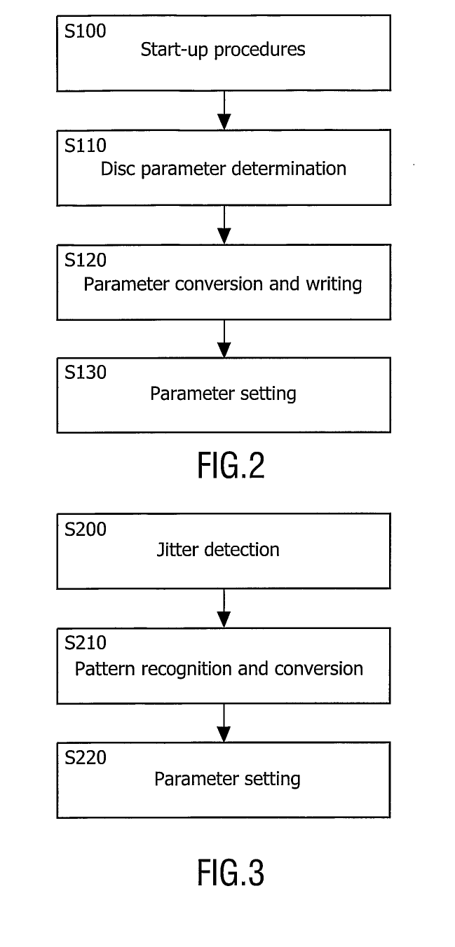

FIG. 2 is a flowchart of an initial disc access operation according to a preferred embodiment,

FIG. 3 is a flowchart of a subsequent disc access operation according to a preferred embodiment,

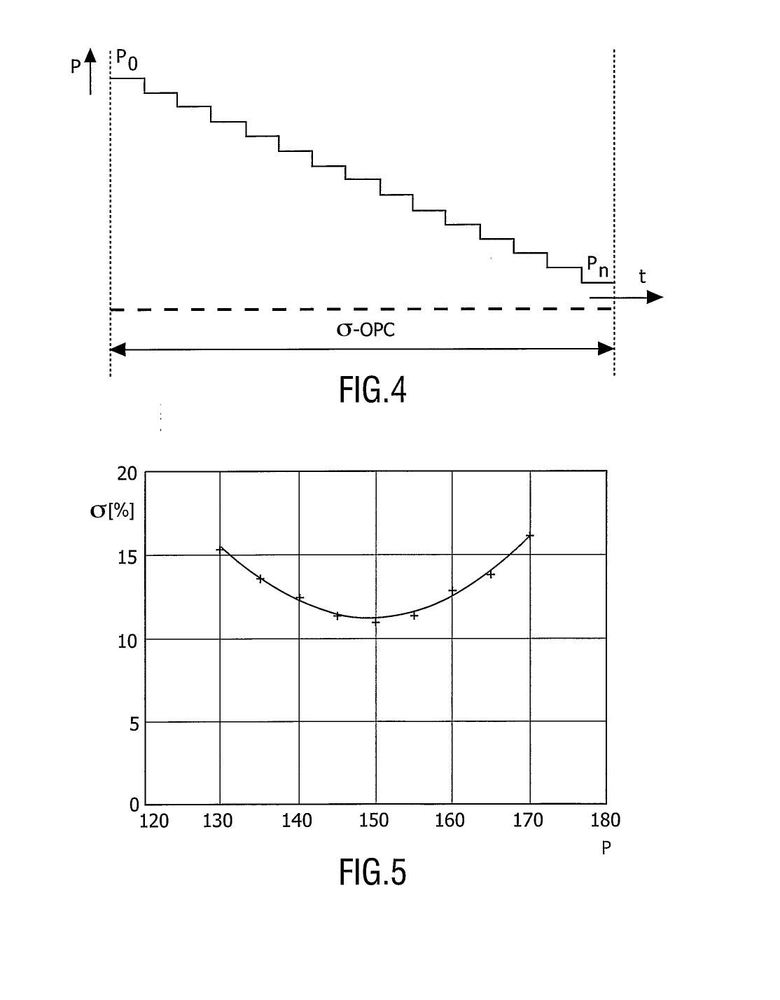

FIG. 4 is a diagram indicating an OPC procedure,

FIG. 5 is a diagram indicating a power/jitter dependency,

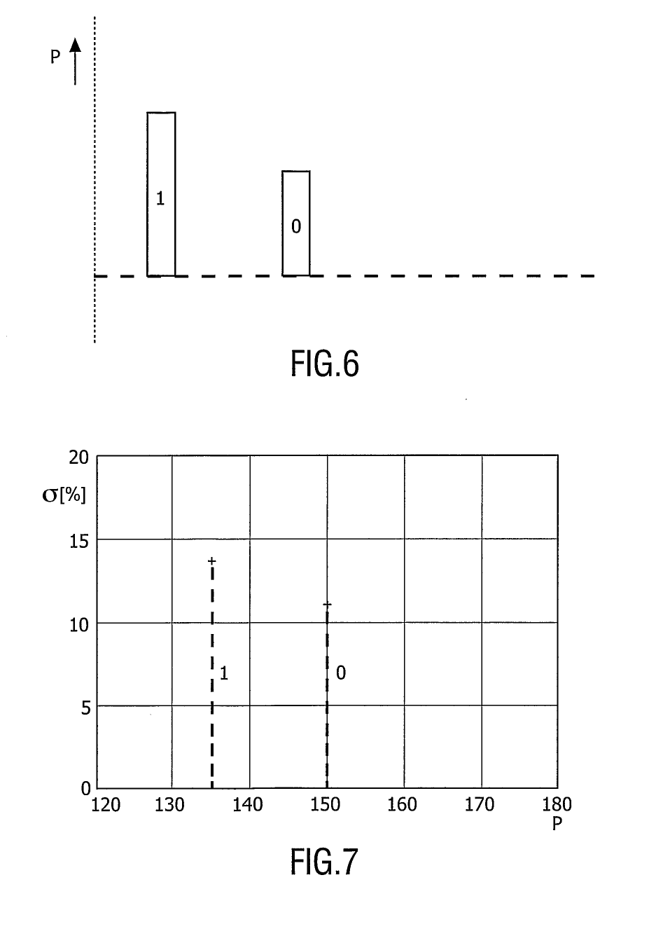

FIG. 6 is a diagram indicating an allocation of selected power values,

FIG. 7 is a diagram indicating jitter levels corresponding to the selected power values, and

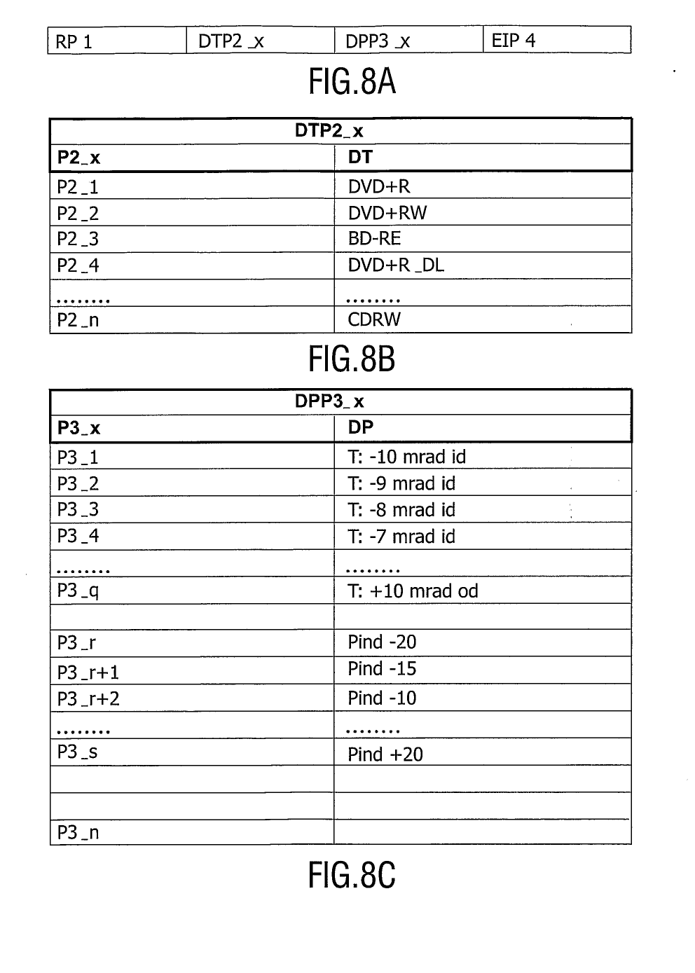

FIGS. 8A to 8C show a pattern block and related pattern tables of disc parameters.

A preferred embodiment will now be described in connection with a drive device for a rewritable optical disc as a specific example of a rewritable record carrier. It is to be noted, however, that the invention is also applicable to devices for other rewritable record carriers where power-based read-out jitter levels can be obtained.

FIG. 1 shows an optical drive device or disc player with an optical disc 60 that can be accessed by means of a read/write laser provided in a pick-up unit 10. It is noted that the block diagram of FIG. 1 merely shows those components of the optical drive device that are required for explaining the present invention.

The pick-up unit 10 is connected to a conversion unit 20 which may be arranged as a separate processing unit or which may alternatively be part of a codec function for coding/decoding data written to and read from the optical disc 60. In particular, the conversion unit 20 serves to convert disc parameters obtained during an initial set-up operation for calibration and/or parameter setting purposes into a writing pattern based on which the power of the read/write laser of the pick-up unit 10 is controlled during an access operation (i.e., a read or write operation) on a predetermined disc area. The disc parameters are recorded on the disc 60 as an information pattern 50 in this manner.

The conversion of the disc parameters into the writing pattern is performed on the basis of a conversion table 40 which may be stored, for example, in a rewritable memory portion of the drive device (e.g., a random access memory or a rewritable read-only memory (ROM) such as an EEPROM (Electrically Erasable ROM). In a specific embodiment, the conversion table may be programmable so as to adapt or update the writing patterns in accordance with changes in the available disc parameters. The initial determination of the disc parameters, the conversion operation of the conversion unit 20, and the parameter setting are controlled by a processing unit 30, which may be a central processing unit (CPU) controlled by predetermined control programmes stored in the drive device. The conversion unit 20 may be implemented by means of a dedicated software routine by which a corresponding operation of the processing unit is controlled.

In a preferred embodiment, disc-related parameters determined during the initial disc setup procedure, for example tilt and/or the optimal write power, are written to specific locations or areas on the disc 60 as predetermined patterns. These written disc parameters can now be read from the disc 60 when it is inserted into the drive device for a second and subsequent time. This shortens the start-up time. In particular, the disc parameters are stored in the disc 60 as well-defined patterns derived from the conversion table 40. After reading these patterns the conversion unit 20 converts them into the original disc parameter values upon any re-loading of the disc 60.

In an embodiment, binary coded patterns representing the disc parameters are written on the disc 60, wherein a first logical value is formed by a mark having a high jitter value and a second logical value is formed by a mark having a low jitter value. These patterns, and therefore the disc parameters, can now be read back during start-up without requiring a repetition of the lengthy set-up procedure for calibrating the specific combination of the disc 60 and the device.

FIG. 2 is a flowchart of an initial disc-access operation that may be used for controlling the processing unit 30. According to FIG. 2, start-up procedures are initiated in step S100 when the optical disc 60 is loaded into the drive device for the first time. Disc recognition calibrations, OPC procedures, etc., are performed during these initial start-up procedures. The required disc parameters are determined on the basis of these procedures in step S110. The determined disc parameters may define, for example, the tangential (BD) and/or radial tilt, the beta target, the RE amplitude, the write power information for the pick-up unit 10, the fiddle factors for the write strategies, and the like. Next, in step S120, the conversion unit 20 is controlled to convert the determined parameters into the binary information pattern to be written onto the predetermined positions of the disc 60 as given by the conversion table 40. As an example for the specific case of a DVD+R disc, these predetermined areas may be the Recorded Area Indicators, the Inner/Outer Disc Count Zone, the Inner/Outer Disc Test Zone, and other suitable areas.

The information pattern 50 is written by controlling the laser power of the pick-up unit 10 in accordance with the converted binary pattern so as to obtain marks in the predetermined areas with jitter values that correspond to the logical values of the patterns. Subsequently, in step S130, or alternatively in parallel to or even before the conversion step S120, the processing unit 30 controls the drive device to set those disc parameters which have been derived from the initial start-up procedures.

Thus, the pattern information 50, which corresponds to the determined disc parameters, can be stored on the disc by writing certain well-defined patterns, for example with two levels, on the disc 60. The drive device may then read out these patterns from the predetermined positions of the disc 60 after re-loading of the disc 60.

FIG. 3 is a flowchart of a subsequent disc-access operation after re-loading of the disc 60 into a drive device. In step S200, jitter is detected from the read-out signal obtained from the pick-up unit 10. Subsequently, in step 210, the obtained jitter values are compared by the conversion unit 20 with the patterns stored in the conversion table 40 for pattern recognition. The recognized patterns are then converted into the corresponding disc parameters. The disc parameters can thus be derived by the drive device without requiring a time-consuming start-up procedure (as depicted in FIG. 2). The processing unit 30 can now perform parameter setting in step S220, using the derived disc parameters, so that a reliable access operation to the disc 60 is ensured.

The conversion table 40 is programmed so as to convert the patterns detected in the jitter levels of the read-out signal into predetermined disc parameters. The relationship between the power of the radiation beam and the jitter level can be calibrated by a jitter (σ) OPC procedure (for example in step S120).

FIG. 4 shows a diagram indicating a stepwise decrease of the power (P) of the radiation beam from a maximum value P₀ to a minimum value Pₙ for performing the σ-OPC procedure. This stepwise decrease of the radiation power leads to a change in the jitter values of a readout signal obtained from a corresponding test writing procedure. FIG. 5 shows the read-back jitter values (σ) corresponding to the test writing with the stepwise decrease in the laser power indicated in FIG. 4. As can be gathered from FIG. 5, a minimum jitter value σ of about 11% is obtained at a relative radiation power of 150, whereas the jitter increases to values above 15% at relative radiation power values of 130 and 170, respectively. The obtained power dependency of the read-back jitter can be used for setting individual radiation power values to be used for writing the information pattern relating to the disc parameter. The information pattern 50 can then be retrieved by measuring and discriminating the jitter values.

FIG. 6 is a diagram of a power (P) allocation where a high power value is used for a logical value “1” and a low power value is used for a logical value “0” of the information pattern 50. It is noted that this power allocation may be reversed. Preferably, the power allocation is such that a sufficient difference between the corresponding jitter values (as shown in the diagram of FIG. 5) is obtained.

FIG. 7 is a diagram indicating selected power (P) values, allocated logical (“0”, “1”) values, and the corresponding jitter (σ) values. As can be gathered from FIG. 7, the jitter changes from about 11% (logical value “0”) to about 14% (logical value “1”) with a corresponding change in the logical values of the information pattern 50. A good differentiation between the logical values in the read-out signal obtained from the pick-up unit 10 is made possible thereby.

An example of a pattern scheme for coding the disc parameters will now be described with reference to FIGS. 8A to 8C. FIG. 8A shows an example of a pattern block. This pattern block comprises a recognition pattern RP1 as a first pattern for recognizing that the information pattern 50 is provided on the disc 60. The recognition pattern RP1 is followed by a second disc type pattern DTP 2_{—}x, which is selected in dependence on the type of the disc 60. Then a third disc parameter pattern DPP 3_{—}x is provided for setting the disc parameters obtained in the initial set-up procedure. Finally, a fourth end-of-information pattern EIB4 is recorded for indicating the end of the information pattern 50 on the disc 60. This structure of the pattern block ensures a reliable detection of the pattern information on the disc 60. To enhance the reliability further, the pattern block may be repeated within the predetermined disc areas on the disc 60 two or more times. When the conversion unit 20 has converted all patterns, the disc parameters are available for the drive application.

FIG. 8B shows, by way of example, an allocation of the patterns P2_1 to P2_{—}n to the different disc types (for example DVD+R, DVD+RW, BD-RE, DVD+R_DL and CDRW). Each of the patterns P2_1 to P2_{—}n corresponds to a predetermined pattern of a predetermined number of logical values.

FIG. 8C shows, by way of example, a table indicating a pattern allocation of the disc parameter pattern DPP 3_{—}x, wherein patterns P3_1 to P3_{—}q are allocated to predetermined tilt values (ranging from −10 mrad to +10 mrad, both inside disc (id) and outside disc (od)). Furthermore, patterns P3_{—}r to P3_{—}s are allocated to power values (ranging from Pind −20 to Pind +20, wherein Pind corresponds to a predetermined relative power value). The remaining patterns P3_{—}s+1 to P3_{—}n may be used for other suitable disc parameters required for drive applications.

It is noted that any other arrangement of patterns in the pattern block and any other kind of allocation of patterns to disc parameters and type of discs may be implemented in the present invention. Moreover, the number of patterns can be selected to suit the desired amount of coded disc parameters. Even the number of values of the patterns may differ when patterns other than binary type patterns are used. More than two power values are selected to produce more than two jitter values in that case.

The present invention is not restricted to the above-described embodiments. It may be applied to any record carrier where the use of different recording power levels leads to distinguishable jitter values in the readout signal. Such record carriers are not limited to disc type record carriers that are rotated in a drive device, but also include record carriers that remain static within the drive device such as, for example, memory card type record carriers.

It should further be noted that the term “comprising” is intended to specify the presence of the stated features, means, steps or components, but does not exclude the presence or addition of one or more other features, means, steps or components or groups thereof. Furthermore, the word “a” or “an” preceding an element in a claim does not exclude the presence of a plurality of such elements. Moreover, any reference sign does not limit the scope of the claims.

1. A drive device for a record carrier (60), said drive device comprising:
determination means (30) for determining at least one parameter which defines at least one characteristic of said record carrier (60),
writing means (10) for writing said determined at least one parameter to a predetermined area of said record carrier by using a predetermined pattern of at least two different power levels, and
reading means (10) for reading said at least one parameter from said predetermined area by detecting jitter values in a read-out signal.

2. A device according to claim 1, further comprising conversion means (20, 40) for converting a pattern derived from said detected jitter values into said at least one parameter.

3. A device according to claim 2, wherein said conversion means (20, 40) comprise a programmable conversion table (40).

4. A device according to claim 1, further comprising calibration means (30) for calibrating said at least two different power levels based on a jitter-related power control function used for setting an optimum power when accessing said record carrier (60).

5. A device according to claim 4, wherein said calibration means (30) are arranged to select said at least two different power levels by using a power-dependent jitter characteristic determined by said power control function.

6. A device according to claim 1, wherein said writing means (10) are arranged to write said predetermined pattern such that at least one power level which corresponds to one logical value has a duration of at least one address frame in a pre-groove writing scheme.

7. A device according to claim 1, wherein said predetermined pattern is arranged as a pattern block comprising a first pattern for recognition, a second pattern for defining a type of record carrier, and/or a third pattern for defining said at least one parameter, and a fourth pattern for defining the end of said pattern block.

8. A device according to claim 7, wherein said writing means (10) are arranged to repeat said pattern block at least once.

9. A device according to claim 1, wherein said at least one parameter defines values of at least one of a tilt, a write power, a beta target, an RE amplitude, and a fiddle factor.

10. A device a according to claim 1, wherein said record carrier is an optical disc (60) and said predetermined area comprises at least one of a recorded area indicator zone, an inner test zone, an outer test zone, an inner disc count zone, and an outer disc count zone.

11. A method of providing at least one parameter which defines at least one characteristic of a record carrier (60) on said record carrier, said method comprising the steps of:
determining said at least one parameter during a first access operation to said record carrier, and
writing said determined at least one parameter to a predetermined area of said record carrier (60) by using a predetermined pattern (50) of at least two different power levels.

12. A method of retrieving at least one parameter which defines at least one characteristic of a record carrier (60) from said record carrier, said method comprising the step of
retrieving said at least one parameter by detecting jitter values in a read-out signal obtained from reading a predetermined area of said record carrier.

13. A record carrier comprising a predetermined recording area in which a predetermined control pattern (50) defining at least one characteristic of said record carrier has been written by means of at least two different power levels so as to make possible a jitter-based read-out of said control pattern (50).
